(19) United States
(12) Patent Application Publication
(10) Pub. No.: US 2007/0153809 A1
(43) Pub. Date: Jul. 5, 2007

(54) Method of multicasting multimedia information over wireless local area network

(76) Inventor: Yuan-Chih Chang, Hsin-Chu City (TW)

Correspondence Address: LIN & ASSOCIATES INTELLECTUAL PROPERTY, P.O. BOX 2339, SARATOGA, CA, 95070-0339, US

(21) Appl. No.: 11/324,403

(22) Filed: Jan. 3, 2006

(51) Int. Cl. H04L 12/28

(52) U.S. Cl. 370/395.53

(57) ABSTRACT

A method for multicasting multimedia information from a transmitting device to multiple receiving devices on a wireless local area network is provided herein. According to the method, the transmitting device, based on the periodical polling of all receiving devices, specifies one of the receiving devices as a master receiving device, and then notifies all receiving device about the MAC address of the selected master receiving device. The receiving devices then change the MAC address of their own network interfaces to the MAC address of the master receiving device by MAC cloning or spoofing. As such, when the transmitting device delivers the multimedia information using one-to-one communications with the master receiving device, the rest of the receiving devices would receive their transmitted information as well.

### BACKGROUND OF THE INVENTION

1. Field of the Invention

The present invention generally relates to wireless local area networks, and more particularly to the information multicasting over a wireless local area network.

2. The Prior Arts

Wireless local area network (WLAN) has gained widespread popularity in recent years as, together with the reduced price tags on the notebook computers and handheld devices, it further fulfills the users' demand for even greater degree of mobility. On the other hand, at another frontier, streaming techniques have been continuously and aggressively enhanced both by the industry and the academia, as they are ubiquitously considered the keystone to the next killer application, the broadcasting or multicasting multimedia programs over the network. The convergence of the WLAN and multimedia broadcasting/multicasting seems to be inevitable but, when that happens, new challenges arise and have to be dealt with.

There are several ways to conduct broadcast or multicast of multimedia information over a typical local area network (LAN). For example, the broadcast frame supported by the network protocol could be used for this purpose. By encapsulating the multimedia information into broadcast frames and put the frames on to the LAN, all devices within the same broadcast domain of the LAN as the issuing device would be able to receive the broadcast frames. However, it is well known to people of the related arts that broadcast frame is not a reliable mechanism. The transmitting device of the broadcast frames does not check the recipient if the broadcast frames have arrived without problem so, if one or more broadcast frames are lost due to collision or other reasons, the transmitting device has no knowledge of the situation. For WLANs, the problem gets worse because WLAN are more susceptible to the interference of noises and as a result more frames would be lost.

Another approach is actually neither broadcast nor multicast, but to conduct one-to-one communications to each of the receiving devices sequentially. In this manner, the transmitting device is capable of detecting frame lost and retransmitting the lost frame. However, as the number of receiving devices increases, the processing power of the transmitting device and the network bandwidth would soon be consumed and this approach is therefore not an efficient and expandable one.

Yet another approach utilizes the promiscuous mode commonly supported by the LAB interface. Under the normal operation mode, the LAN interface of a device would only retain and process the frames having the device's address as the destination address. Under the promiscuous mode, the LAN interface would retain and process all frames, regardless of their destination addresses. The promiscuous mode is designed originally for network traffic monitoring and trouble shooting. By taking advantage of the special function provided by the promiscuous mode, when one transmitting device is conducting one-to-one communications to a specific receiving device, the rest of the device also on the same LAN could turn on their promiscuous mode and “overhear” the frames sent by the transmitting device. However, the indiscriminating reception of all frames by the promiscuous mode would lead to an overwhelming amount of frames to a “tapping” device, which means that a huge frame buffer and a filtering mechanism are required to screen out the truly useful frames, and all these would take a heavy toll on the device. Another problem with this approach is that not all devices' LAN interfaces support the promiscuous mode.

Despite the progress in encoding and compression techniques, the transmission of multimedia information would still require a staggering amount of network bandwidth. On the other hand, even though there are already wired LANs running at 1 Gbits/sec or 10 Gbits/sec, the existing WLAN technologies are still quite inferior. Therefore, the challenges before the broadcasting/multicasting multimedia information over a WLAN are about guaranteeing a certain degree of multimedia quality without overloading the transmitting/receiving devices under the limited bandwidth provided by WLAN. In addition, in contrast to a wired LAN where all receiving devices would receive multimedia information within substantially identical quality from the same transmitting device, this is not the case on a WLAN where, depending on the coverage of WLAN and the relative locations of the transmitting/receiving devices, there could be significant differences between the quality of the multimedia information received by the receiving devices. How to guarantee that multiple receiving devices all have roughly identical quality of multimedia information delivered to them is yet another challenge to address.

### SUMMARY OF THE INVENTION

Accordingly, the present invention provides a method for multicasting multimedia information over a WLAN so as to obviate the shortcomings of conventional approaches.

A major aspect of the present invention is that no additional hardware devices, no additional frame buffer space, and no additional computational capacity are required on the receiving devices. A receiving device implementing the present invention would basically require the same amount of resources as when it engages in one-to-one communications.

Another major aspect of the present invention is that the network bandwidth consumed by the multicasting of multimedia information of a transmitting device, on one hand, is about the same as when the transmitting device engages in one-to-one communications and, on the other hand, has nothing to do with the number of receiving devices.

Yet another major aspect of the present invention is that, regardless of the number and locations of the receiving devices, the multimedia information received by these receiving devices would have roughly the same quality as long as they are within the coverage of the WLAN. Additionally, the present invention is able to dynamically adjust the transmission according to the current locations of the receiving devices.

The method disclosed by the present invention mainly contains two parts, one implemented on the transmitting device and the other one implemented on each of the receiving devices. The two parts run in parallel and interact with each other.

The part implemented on the transmitting device mainly contains an administration process and an arbitration process. The administration process accepts the registration of the receiving devices, records relevant information about the receiving devices, and informs a logging-on receiving device about the address of the master receiving device. The arbitration process periodically polls all receiving devices and, based on their respective transmission quality revealed by the reply messages to the poll, decides a new mater receiving device. If the current master receiving device does not reply to the poll, the arbitration process would also decide a new master receiving device. Once a new mater receiving device is determined, the arbitration process broadcast the address of the new master receiving device to all receiving devices. According to the present invention, the multicasting of multimedia information is achieved by having the transmitting device to engage in one-to-one communications with the master receiving device while the rest of the receiving devices conceal their own addresses and assume the address of the master receiving device by a technique named MAC cloning so that the receiving devices other than the master receiving device “fool” their WLAN interfaces into receiving the frames originally destined only for the mater receiving device.

The part implemented in each of the receiving devices mainly contains a logon process and a response process. When a device would like to join the multicasting and starts to receive multimedia information, the logon process first locates the transmitting device, logs onto the transmitting device, and informs the transmitting device about its own address along with other information. On the other hand, the transmitting device would return the address of the master receiving device to the logging-on device. If the device is itself the master receiving device, it engages in one-to-one communications with the transmitting device. If the device is not the master receiving device, it will change the address of its WLAN interface to that of the master receiving device and start to receive, but does not respond to, the frames sent to the master receiving device.

The response process is triggered by the reception of relevant messages from the transmitting device. If it is a poll message, the receiving device simply returns a reply message to the transmitting device. If it is an notification message about the establishment of a new mater receiving device, the receiving device engages in one-to-one communications with the transmitting device, if it is the new master receiving device itself, otherwise it will change the address of its WLAN interface to that of the new master receiving device and start to receive, but does not respond to, the frames sent to the new master receiving device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing an application environment of the present invention.

FIG. 2a is a flow diagram showing the administration process of the transmitting device according to the present invention.

FIG. 2b is a flow diagram showing the arbitration process of the transmitting device according to the present invention.

FIG. 3a is a flow diagram showing the logon process of the receiving device according to the present invention.

FIG. 3b is a flow diagram showing the response process of the receiving device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

A method of conducting one-to-many transmission (multicasting) of multimedia information over a WLAN is provided herein. The term “multimedia information” is used here to refer to audio-only information, video-only information, or information containing both audio and video. Please note that the spirit of the present invention can actually be applied to the multicasting any large-volume information over a WLAN. On the other hand, the present invention also does not impose any specific constraints on the encoding and transmission protocols of the multimedia information or any similar large-volume information.

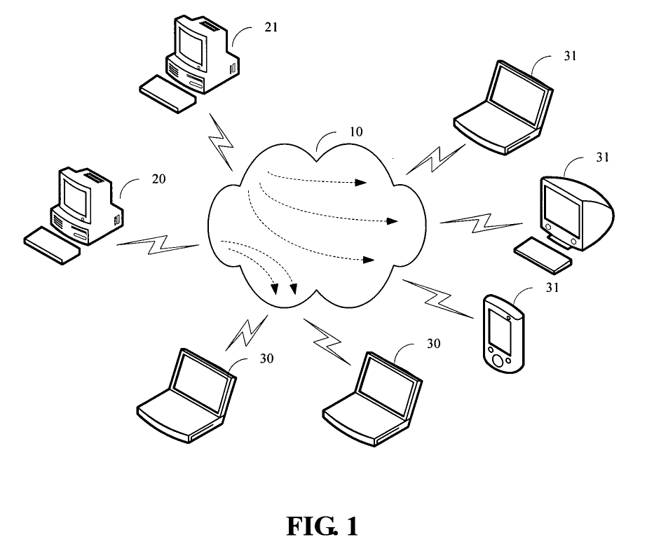

FIG. 1 is a schematic diagram showing an application environment of the present invention. As illustrated, the present invention is implemented on the devices connected to a WLAN 10. The WLAN 10 could be one supporting an existing protocol such as 802.11a/b/g or any possible protocol that would be developed in the future. According to the present invention, the devices connected to the WLAN 10 and participating the multicasting are divided into transmitting devices 20 sending multimedia information and receiving devices 30 receiving the multimedia information. The method provided by the present invention are implemented on the transmitting devices 20 and the receiving devices 30, as software modules, or as firmware programs stored inside some chips, or some combinations of the two. The most common examples of the transmitting and receiving devices 20 and 30 are general-purposed and WLAN-enabled computers. However, depending on the applications, the transmitting and receiving devices 20 and 30 can take various different forms. For one example, the receiving devices 30 could be the information kiosks commonly seen in malls or stations. The most important characteristics of the transmitting and receiving devices 20 and 30 are that they are capable of WLAN communications and capable of executing the method provided by the present invention.

The multimedia information delivered by a transmitting device 20 could be stored inside the transmitting device 20 in advance, or obtained concurrently from an external source. Over a single WLAN 10, there could be more than one transmitting device operating simultaneously, each of which is associated with a separate group of receiving devices. For example, some receiving devices 30 receive from a transmitting device 20 while some other receiving devices 31 receive from another transmitting device 21.

The method of the present invention relies on an existing technique named MAC cloning or MAC spoofing. When a LAN or WLAN interface adaptor is manufactured, it is assigned a universally unique MAC (media access control) address by the manufacturer, which is used to address the LAN or WLAN interface adaptor in the frames of the second network layer. Under the normal operation of the interface adaptor and when a frame passes through the media of the LAN or WLAN, the interface adaptor examines the destination address of the frame to see if it matches its own MAC address. If the two match, the payload of the frame is extracted for further processing; otherwise, the frame is discarded as it is destined to other devices. MAC address is usually stored in an EEPROM (electrically erasable programmable read-only memory) of the interface adaptor and therefore could be modified or replaced. Assuming that all the receiving devices 30 have their MAC address “cloned” or “spoofed” to an address (X) by the above technique, they will all be able to receive the frames sent from a transmitting device 20 if the frames all have (X) as the destination address. As a result, a multicasting-like effect is achieved and, most importantly, the effect is achieved not at the cost of additional bandwidth consumption and has nothing to do with the number of receiving devices. Additionally, no additional hardware devices, no additional frame buffer space, and no additional computational capacity are required beyond what is required for the normal one-to-one communications.

Therefore, the major characteristics of the present invention are about which MAC address to use and how to guarantee roughly identical multimedia quality for all participating receiving devices. The method provided by the present invention mainly contains two parts. One part is implemented in the transmitting device, and the other part is implemented on each of the receiving devices. The two parts run in parallel and interact with each other. The part in the transmitting device is described first as follows.

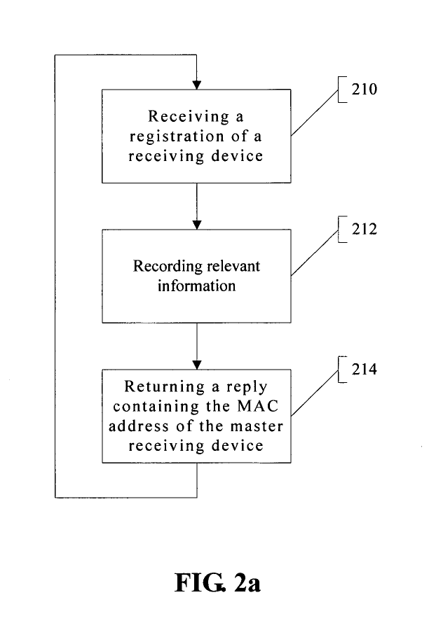

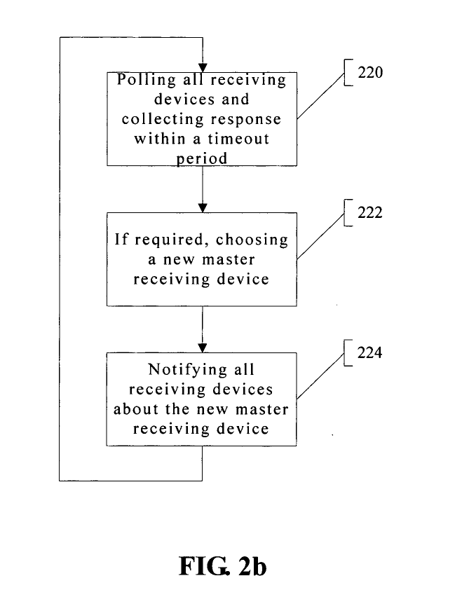

The part in the transmitting device mainly contains an administration process and arbitration process. FIG. 2a is a flow diagram showing the administration process of the transmitting device according to the present invention, whose execution is triggered by the reception of a logon message from a device intended to receive the multimedia information, as in step 210. From the frame or packet carrying this logon message, the transmitting device is able to retrieve various information about this new receiving device such as its MAC address (from the source address field of the frame), IP address (from the source address field of the packet), etc. Then, in step 212, the transmitting device keeps the information in a storage space for subsequent usage and, in step 214, a reply message is returned to the new receiving device, which mainly contains the MAC address of the master receiving device.

The master receiving device is one of the receiving devices that has a special role. At any time, there can be only one receiving device functioning as the master receiving device. From the transmitting device's point of view, the transmitting device engages one-to-one communications to the master receiving device in sending the multimedia information and, therefore, the frames all carry the MAC address of the master receiving device as the destination address. If the receiving device is the first one participating in the reception of the multimedia information, in step 214, it is naturally assigned the role of the master receiving device and its MAC address will be contained in the reply message returned to it form the transmitting device. On the other hand, if there is an existing master receiving device, in step 214, the MAC address of the current master receiving device is contained in the reply message. At last, the process returns to the step 210 to wait for next logon message.

FIG. 2b is a flow diagram showing the arbitration process of the transmitting device according to the present invention. The purpose of having the arbitration process is to choose another receiving device as the new master receiving device. The execution of the arbitration process is automatically and periodically triggered with an appropriate cycle time when there is at least a receiving device present. When the arbitration process is triggered, the transmitting device first polls all receiving devices and collects their responses in step 220. There are various ways to implement the step 220. For example, a broadcast frame supported by the layer 2 protocol could be used to send out the poll message, or an ordinary frame using the MAC address of the master receiving device as destination address could be used. As will be explained later, all receiving devices should have replaced their MAC address by the MAC address of the master receiving device and therefore all receiving devices will be able to receive the poll message. Then, the transmitting would wait and collect the reply message from all receiving devices within a specific timeout period.

In step 222, based on all the reply messages collected, the transmitting device decides whether to pick a new master receiving device and, if yes, an appropriate selection method is conducted. In an embodiment of the present invention, the arbitration process picks a new master receiving device only when the current master receiving device is not responding (i.e., the current master receiving device is disconnected, shut down, or outside the coverage of the WLAN). In an alternative embodiment, the arbitration process would always pick a new master receiving process regardless of whether the current master receiving device has responded or not. There are also various selection methods that could be adopted. For example, one selection method randomly picks one from all the receiving devices that have responded, or another selection method, based on the response times of the reply messages, pick the one that has the longest response time. Another possible method is that, by having each of the receiving devices to record the radio signal strength it has perceived in the reply message, the one receiving device perceiving the weakest radio signal is selected. The longest response time or the weakest radio signal implies that the receiving device encounters the worst transmission quality from the transmitting device. By choosing the one having the worst transmission quality as the new master receiving device, the transmitting device's one-to-one communications with the master receiving device would certainly encounter more frame loss or delay than with other receiving devices. According to the communications protocol, the master transmitting device would engage various control means such as flow control and re-transmissions to make up the lost or delayed frames and, as a result, the rest of the receiving devices would be “blessed” by these transmission quality improvement acts performed by the transmitting device. In other words, the transmission quality experienced by the rest of the receiving devices cannot be worse than that experienced by the master receiving device. Please note that, by having some identification information (e.g., the original MAC address of the receiving device) embedded in the reply message, even though all receiving devices have identical, “cloned” MAC addresses, the transmitting device is able to tell which reply message is from which receiving device.

Subsequently, in step 224, if a new master receiving device is determined, the transmitting device would issue a notification message to all receiving device about the MAC address of the new master receiving device. To determine the MAC address of the new master receiving device, the transmitting device could use the identification information contained in the reply message to search its storage space or, as mentioned, the original MAC address of the receiving device is included in the reply message directly. Again, the transmitting device could use the broadcast frame supported by the communications protocol, or an ordinary frame with the MAC address of the current master receiving device as the destination address. At last, the process returns to the step 220, waiting for the next cycle to expire.

It has to stressed again that the multicasting of multimedia information performed by the present method is achieved by engaging one-to-one communications between the transmitting device and the master receiving device while the rest of the receiving devices take a free ride in receiving the frames of the one-to-one communications by “cloning” the MAC address of the master receiving device. Therefore, after the notification message about a new master receiving device being elected is delivered, the transmitting device starts to conduct one-to-one communications with the new master receiving device.

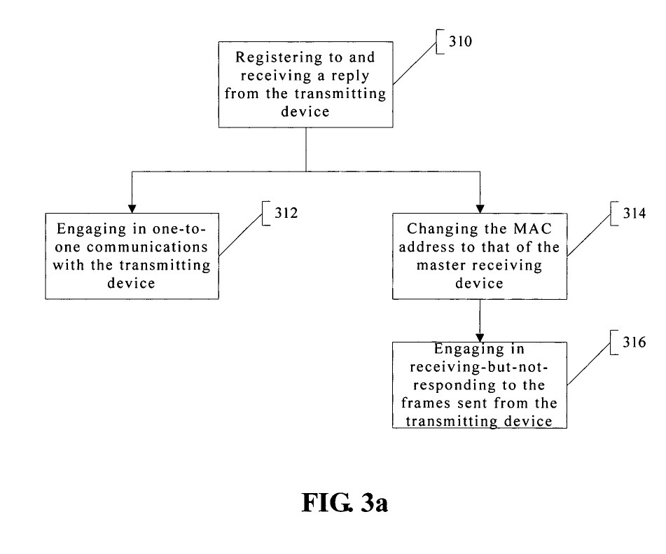

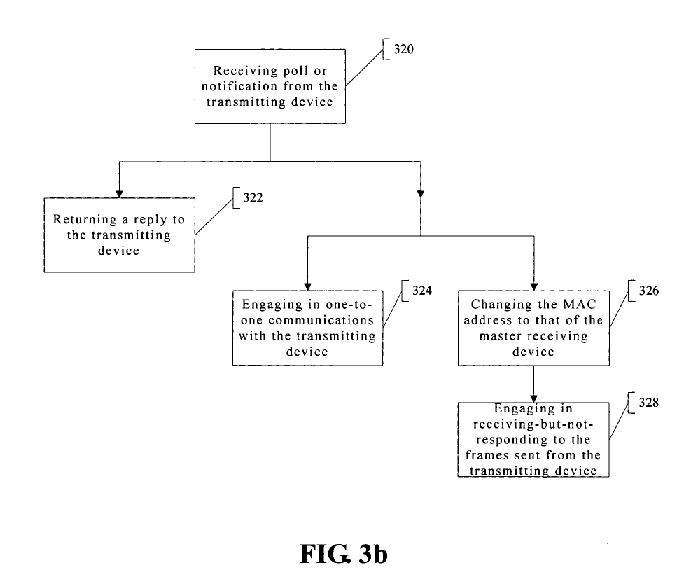

The other part of the present method implemented in the receiving device mainly contains a logon process and a response process. FIG. 3a is a flow diagram showing the logon process of the receiving device according to the present invention. As shown, when a device is intended to receive the multimedia information from the transmitting device, in step 310, it first sends a logon message to the transmitting device, registering itself to the transmitting device by providing various information such as its MAC address to the transmitting device. There are also various ways to implement the step 310. For example, a broadcast frame carrying this logon message could be put on the WLAN. As mentioned, the transmitting device would return a reply message containing the MAC address of the current master receiving device. From this reply message, if the device discovers that it is the master receiving device by comparing its own MAC address of the MAC address contained in the reply message, the device would configure itself to engage one-to-one communications with the transmitting device in step 312. On the other hand, if the master receiving device is someone else, the device changes its MAC address to that notified by the transmitting device in step 314 using MAC cloning or spoofing. Then, in step 316, the device configures itself into a mode of operation that receives but not responds the frames having that specific MAC address as destination address. Please note that, even though not illustrated in the diagram, the device would always keep its original MAC address in a storage space for future restoration of the original MAC address.

FIG. 3b is a flow diagram showing the response process of the receiving device according to the present invention. The response process is triggered by the reception of the poll message and the notification message from the transmitting device, in step 320. If it is a poll message, the receiving device returns a reply message to the transmitting device in step 322, in which some identification information or the original MAC address is encapsulated. If it is a notification message and if the receiving device itself is the master receiving device by comparing its original MAC address with the MAC address contained in the reply message, the device would “clone” itself back to its original MAC address and configure itself to engage one-to-one communications with the transmitting device in step 324. On the other hand, if the master receiving device is someone else, the receiving device changes its MAC address to that notified by the transmitting device in step 326, again, using MAC cloning or spoofing. The device also configures itself into the listen-only mode of operation in step 328. After the steps 322, 324, and 328, the process returns to the step 320, waiting for the next poll or notification message.

The transmitting device and the receiving devices should contains other processes such as those for sending the multimedia information, for receiving frames in one-to-one or listen-mode mode of communications. However, these should be quite obvious to those skilled in the related arts and therefore are omitted here for simplicity. However, certain aspects of the present invention require further explanation as follows. When a receiving device decides not to receive the multimedia information from the transmitting device, it could notify the transmitting device or it could simply and directly terminate its relevant processes. For the latter, the transmitting device could remove the information about a receiving device from its storage space if the receiving device does not respond after several rounds of polling. Please note that the same scenario would occur if the receiving device is crashed, shut down, or outside the WLAN coverage. When a receiving device decides to quit from the multicasting, the receiving device will always restore its original MAC address also using MAC cloning or spoofing.

In contrast, if it is the transmitting device intending to terminate the multicasting of the multimedia information, the transmitting device could notify all receiving devices first or it could also simply and directly terminate its relevant processes. For the latter, the receiving devices could terminate its own processes if no poll message or no multimedia frames are received from the transmitting device after a specific timeout period. Please note that the same scenario would occur if the transmitting device is crashed, shut down, or outside the WLAN coverage.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of multicasting multimedia information from a transmitting device to a plurality of receiving devices through a WLAN, each of said receiving devices capable of changing its MAC address by MAC cloning, said method comprising two parts implemented in said transmitting device and each of said plurality of receiving devices respectively, the part implemented in said transmitting device comprising the steps of:
(a1) polling said plurality of receiving devices periodically according to an appropriate cycle and collecting responses from said plurality of receiving devices within an appropriate timeout period;
(a2) choosing a receiving device from said plurality of receiving devices that respond as a master receiving device according to said responses and an appropriate selection method; and
(a3) notifying said plurality of receiving devices about the MAC address of said master receiving device and then engaging in one-to-one communications with said master receiving device to deliver the multimedia information; and
the part implemented in a receiving device comprising the steps of:
(b1) replying a response to said transmitting device after being polled by said transmitting device;
(b2) engaging in one-to-one communications with said transmitting device to receive the multimedia information after receiving an notification from said transmitting device and said receiving device being identified as said master receiving device by said notification;
(b3) changing the MAC address of said receiving device to the MAC address of said master receiving device and engaging in receiving but not responding to the frames sent from said transmitting to said master receiving device.

2. The method according to claim 1, wherein said step (a1) polls said plurality of receiving devices by sending out a broadcast frame over said WLAN.

3. The method according to claim 1, wherein said step (a1) polls said plurality of receiving devices by sending out a frame having the MAC address of said mater receiving device as the destination address.

4. The method according to claim 1, wherein said step (a2) is conducted only when there is no response from said mater receiving device.

5. The method according to claim 1, wherein said selection method of said step (a2) is random selection.

6. The method according to claim 1, wherein said selection method of said step (a2) is to choose a receiving device having the longest response time.

7. The method according to claim 1, wherein said response of said step (b1) contains the radio signal strength experienced by said receiving device and said selection method of said step (a2) is to choose a receiving device having the weakest radio signal strength.

8. The method according to claim 1, wherein said response of said step (b1) contains an identification information and said identification information is used by said step (a3) to determine the MAC address of said master receiving device.

9. The method according to claim 8, wherein said an identification information is the original MAC address of said receiving device.

10. The method according to claim 1, wherein said step (a3) notifies said plurality of receiving devices by sending out a broadcast frame over said WLAN.

11. The method according to claim 1, wherein said step (a3) notifies said plurality of receiving devices by sending out a frame having the MAC address of said mater receiving device as the destination address.

12. The method according to claim 1, wherein the part implemented in a receiving device further comprising the following steps before said steps (b1)˜(b3):
(c1) registering to said transmitting device and receiving a reply from said transmitting device;
(c2) engaging in one-to-one communications with said transmitting device to receive the multimedia information if said receiving device being identified as said master receiving device by said reply; and
(c3) changing the MAC address of said receiving device to the MAC address of said master receiving device and engaging in receiving but not responding to the frames sent from said transmitting to said master receiving device if said receiving device not being identified as said master receiving device by said reply; and
the part implemented in said transmitting device further comprising the following steps executed in parallel with said steps (a1)˜(a3):
(d1) receiving the registration of a receiving device;
(d2) recording relevant information about said receiving device; and
(d3) returning a reply to said receiving device which contains the MAC address of said master receiving device.

13. The method according to claim 12, wherein said step (c1) performs registration by sending out a broadcast frame over said WLAN.

14. The method according to claim 12, wherein the part implemented in a receiving device further comprising the steps of:
memorizing the original MAC address of said receiving device.

15. The method according to claim 12, wherein the relevant information of said step (d2) comprises the MAC address of said receiving device.

16. The method according to claim 12, wherein said step (d3) chooses said receiving device as said mater receiving device if said receiving device is the first one registering to said transmitting device.

17. The method according to claim 1, wherein the part implemented a receiving device further comprising the following step after terminating the reception of the multimedia information:
restoring the original MAC address of said receiving device.
